(19) United States
(12) Patent Application Publication
(10) Pub. No.: US 2004/0124017 A1
(43) Pub. Date: Jul. 1, 2004

(54) Apparatus and method for weighing the occupant of a bed

(76) Inventors: David Lane Jones, Houston, TX (US); John Frederick Jones, Bedford, IN (US)

Correspondence Address: MR. DAVID JONES, MOBILITY INNOVATIONS, INC., 3806 PINEMONT, HOUSTON, TX, 77018, US

(21) Appl. No.: 10/240,229

(22) PCT Filed: Mar. 30, 2001
(86) PCT No.: PCT/US01/10228

(51) Int. Cl. G01G 19/52; G01G 5/04

(52) U.S. Cl. 177/144; 177/254

(57) ABSTRACT

Weighing apparatus (1) which is comprised of at least two weight sensing elements (12) that are connected to each other by at least one communication cable (48) and are preferably positioned either adjacent to or at each end of bed in order to support bed. In one embodiment, each weight sensing element (12) comprises a weight sensing base (11) and at least a pair of mounting assemblies (7) that may be at or adjacent to the head and foot of bed. Preferably, weight sensing base (11) extends laterally and mounting assemblies (7) extend vertically. Each weight sensing base (11) is supported by the corresponding pair of mounting assemblies (7). The method of operation of weighing apparatus is based on a two-mode operation: TARE mode operation and WEIGH mode operation. The principals of operation of weighing apparatus are a summation of load points that are established when bed, under its own controls, is lowered to a position that allows bed and its contents to rest on weighing apparatus.

### Related Applications

This application is a continuation in part of the U.S. application Ser. No. 09/538,459, filed 30 Mar. 2000 co-owned and co-pending herewith and incorporated by reference for all legitimate purposes.

### FIELD OF THE INVENTION

This invention relates generally to an apparatus for and a method of weighing an occupant of a bed and in particular to such apparatus and method for weighing a bedridden patient.

### BACKGROUND OF THE INVENTION

Doctors like to monitor the weight gain or loss of patients under their care. Generally, this is no problem for most patients, but for those who are bedridden or find it difficult to get into and out of bed, it can create a stressful event for a patient. The situation os exacerbated when frequent weighing is required each day to monitor a patient's weight loss or weight gain.

In addition, living things and objects which are individually held or supported by any object or device may need to be weighed individually. Removing the living things and objects from the corresponding holding or supporting object or device and returning the living things and objects back to their original container and position may be a cumbersome task that may need to be repeated numerous times.

### SUMMARY OF THE INVENTION

a weighing apparatus that enables any hospital bed to be converted to a scale. The weighing apparatus in one embodiment comprises a plurality of weight sensing instruments mounted to a bed or in a kit removably mountable to a bed. The weight sensing instruments are communicatively coupled to each other and to a user interface to provide signals that are combined to provide the total weight of the bed and its content, namely the patient. In accordance with this invention, weight sensing instruments are preferably positioned either adjacent to or at each end of bed in order to support bed. In one

embodiment, each weight sensing instrument comprises a weight sensing base and a corresponding mounting assembly. For example a pair of weight sensing instruments may be attached into one base at the head of the bed and another pair may be attached in a base at the foot of the bed. In another embodiment a plurality of weight sensing instruments may be attached to support te bed as at or adjacent to each leg of a bed. Preferably, the mounting assemblies extend or are extendable vertically from the bed to below the frame and may be brought into contact with the floor by raising the bed legs or by lowering the mounting assemblies. With a hospital bed the mechanism, for raising the leg (ie. lowering the bed) are typically already available. In addition, a power source such as a power cord is used for transferring electrical power to weighing apparatus. A pendant assembly or a user interface is used for operating weighing apparatus. A pendant cord connects hand-held pendant to weight sensing elements upon being plugged into either weight sensing element. The method of operation of weighing apparatus is based on a two mode operation: TARE mode operation and WEIGH mode operation. The principals of operation of weighing apparatus are a summation of load points that are established when bed, under its own controls, is lowered to a position that allows bed and its contents to rest on weighing apparatus.

It is an object and feature of this invention to provide an apparatus for and a method of weighing a living thing or object resting on a bed or on any other holding device.

Another object of this invention is to enable weighing a living thing or an object frequently or regularly without having to move the living thing or object out of bed or of any other holding device and onto scales.

A further object and feature of this invention is that the weight of a living thing or an object in a bed or in any other holding device can be measured regardless of the position of the living thing or object on the bed or in any other holding device.

A further object is to provide a temperature compensation apparatus such as a controlled operating temperature or alternatively a temperature sensor and a computer program to compensate for changes in weighing instrument out put due to temperature variations over time.

A further object is to provide a memory and computer program controls for periodically taking weight measurements over time intervals and recording, storing and displaying the recorded weight trends to the user at the user interface.

These and other objects, advantages and features of this invention will be apparent to those skilled in the art from a consideration of this specification including the attached drawings and appended claims.

### BRIEF DESCRIPTION OF THE DRAWINGS

Some embodiments of the invention will be described in detail below with reference to the following drawings:

FIG. 1 is a top sectional view of a weight sensing element of a weighing apparatus.

FIG. 2 is a side sectional view of the weight sensing element of FIG. 1.

FIG. 3 is a partly exploded view of a weighing apparatus.

FIG. 4 is an elevation view of a bed with legs that is equipped with a weighing apparatus, said weighing apparatus comprising two weight sensing elements used for measuring the weight of the bed.

FIG. 5 is a vertical sectional view of the bed of FIG. 4, with the weight sensing element being elevated, but with the leg not being elevated and showing an alternative attachment of the mounting assembly in phantom lines.

FIG. 6 is a version of FIG. 5, with neither the weight sensing element nor the leg being elevated.

FIG. 7 is a version of FIG. 6, with the leg being elevated, but with the weight sensing element not being elevated.

FIG. 8 is a lateral side view, partly in section, of a section of the bed of FIG. 4.

FIG. 9 is a sectional view of a mounting assembly of FIG. 4.

FIG. 10 is a sectional view of a lower section of a mounting assembly.

FIG. 11 is a view partly in section and partly in elevation of a section of a bed with a leg and a weight sensing element that is not connected to the leg of the bed.

FIG. 12 is a view partly in section of a section of a bed with a frame and a weight sensing element that is connected to the frame of the bed.

FIG. 13 is a schematic view of a bed with a plurality of weight sensing instruments, one at or adjacent to each leg of a bed.

FIG. 14 is an exploded view other apparatus of this invention for supporting one leg of the bed and for transmitting an electrical analog signal indicating the pressure corresponding to the weight the leg is supporting and providing the analog signal to an analog to digital converter (A/D) so the analog signal from the leg is converted into a digital signal representative of the weight and so that the sum of all the eight signals from al the plurality of weight sensing instruments represents the weight of the bed and the patient.

FIG. 15 is a schematic diagram of a circuit for combining the output of the weight sensors at each leg of the bed and deducting the tare to obtain the weight of the patient.

FIG. 16 is a schematic diagram of the four weight sensing instruments communicating with a central user interface having a CPU, memory, and programing for providing weight data information and for recording weight trending or data at selected time intervals over a period of time.

### DETAILED DESCRIPTION

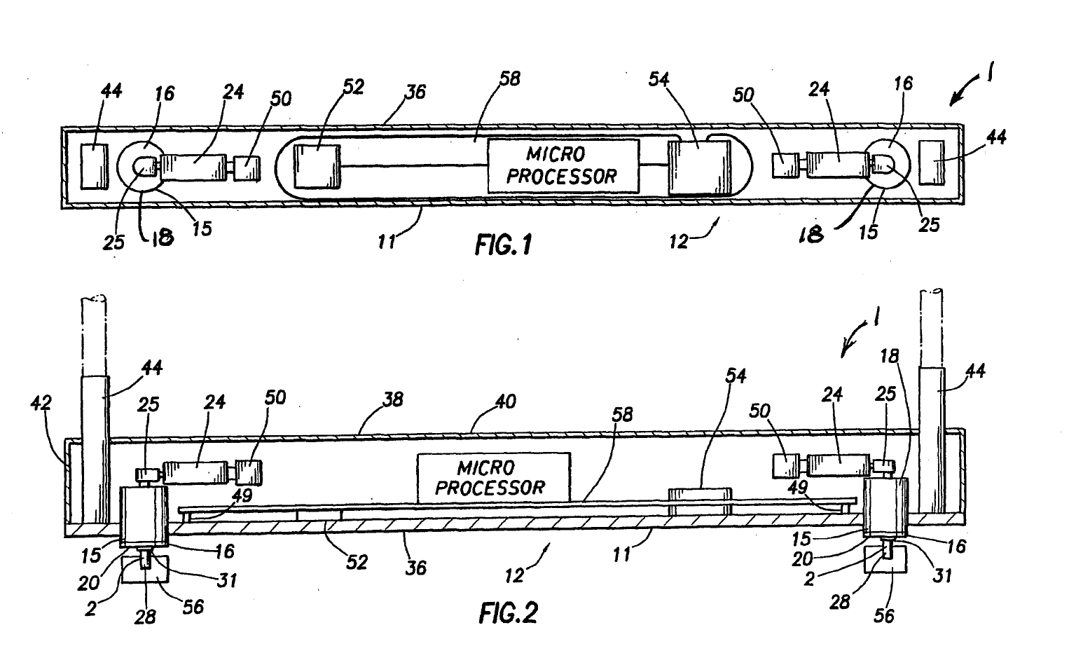

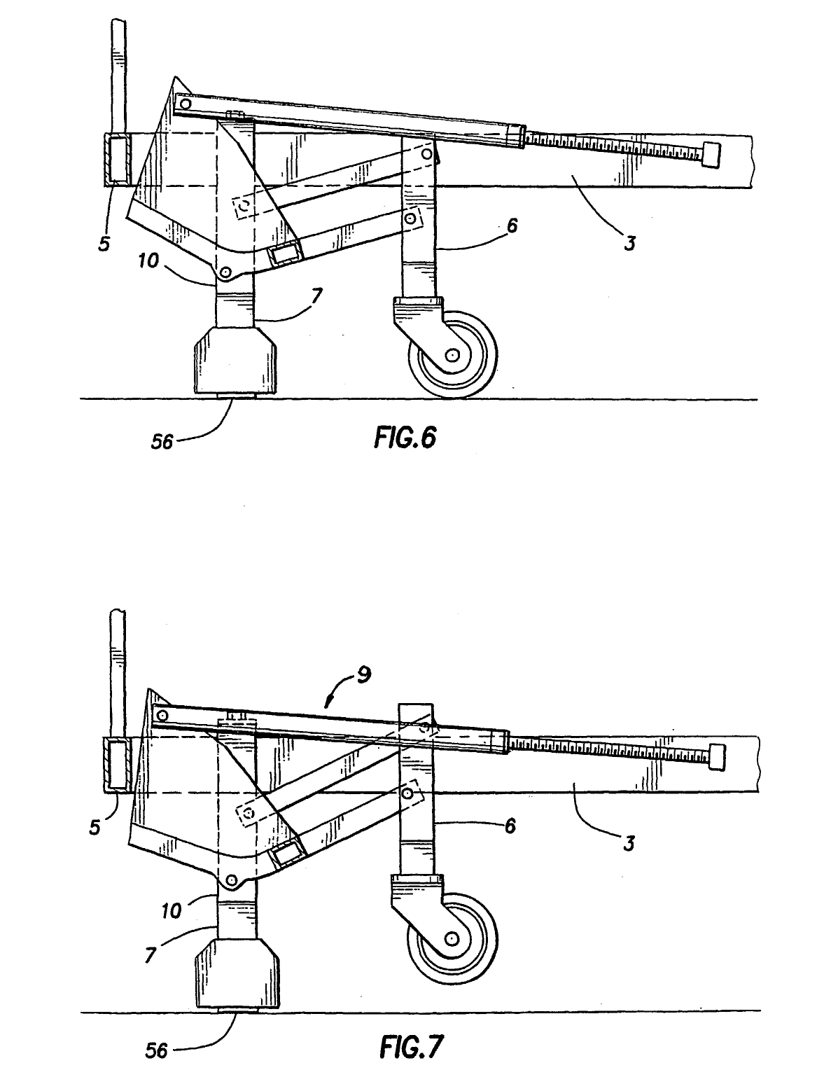

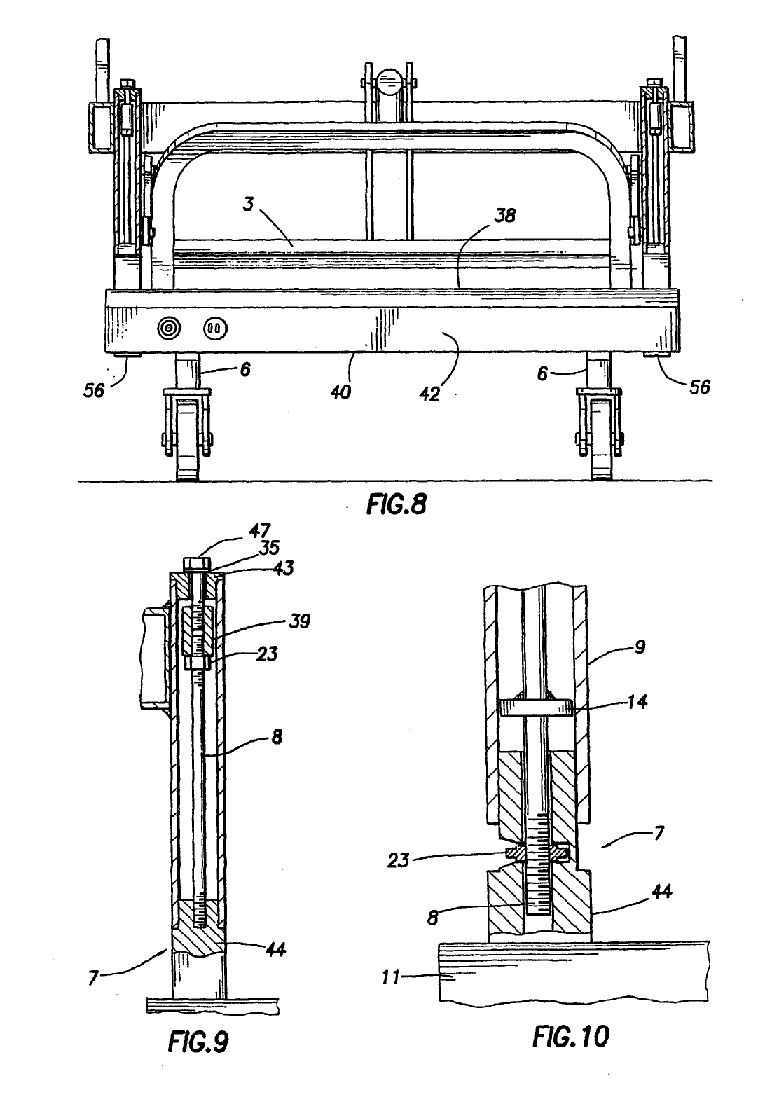

The present invention is a weighing apparatus is that can be used to weigh almost anything but will be described here as used on a bed 3, such as shown in FIGS. 1-16. (The term “bed” is used herein to include, but not be limited to, any health care bed or any other device or object for individually holding or supporting someone and/or something.) Each bed 3 has a frame 5 and legs 6 that are connected to or extend from frame 5. As long as weighing apparatus is connected to bed 3 and is positioned between the floor and frame 5 of bed 3, there is no limitation to position of weighing apparatus 1. Preferably, weighing apparatus is positioned in areas at or adjacent to head and foot of bed 3. Bed 3 has mechanisms 9 to raise and lower bed 3 to engage and disengage weighing apparatus 1. To engage weighing apparatus 1, bed 3 is lowered to a position that allows the entire bed and its contents to rest on weighing apparatus 1, thus turning the entire bed into a weighing platform.

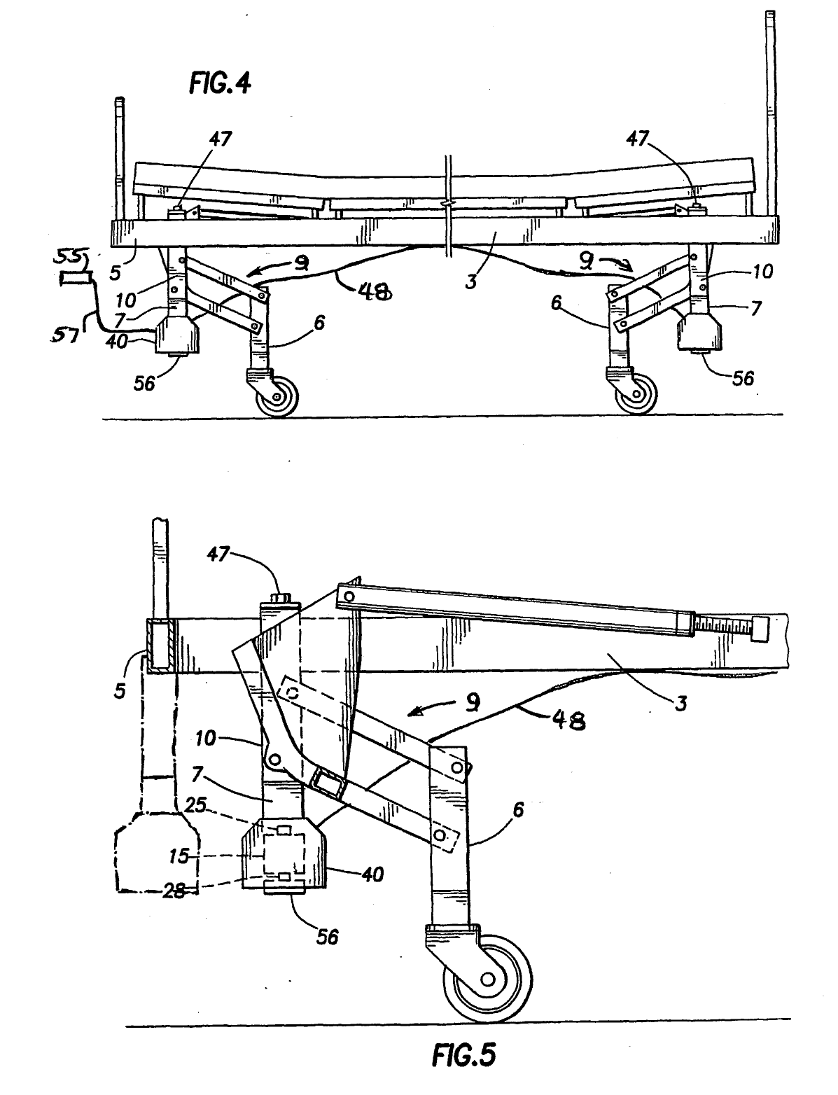

Weighing apparatus 1 in this embodiment comprises at least two weight sensing elements 12 comprising pairs of weight sensing instruments 18 (as shown in FIG. 3) that are communicatively connected to each other as by a communication cable 48. In accordance with this invention, weight sensing elements 12 are positioned either adjacent to or at each end of bed 3 with the weight sensing instruments 18 spaced apart in order to support bed 3. In this embodiment, each weight sensing element 12 comprises a weight sensing base 11 and at least a pair of mounting assemblies 7 that may be at or adjacent to the head and foot of bed 3 (as shown in FIGS. 3 and 4). Weight sensing base 11 extends laterally and mounting assemblies 7 extend vertically. Each weight sensing base 11 is supported by corresponding mounting assemblies 7. Each communication cable 48 connects a pair of weight sensing bases 11 to one another.

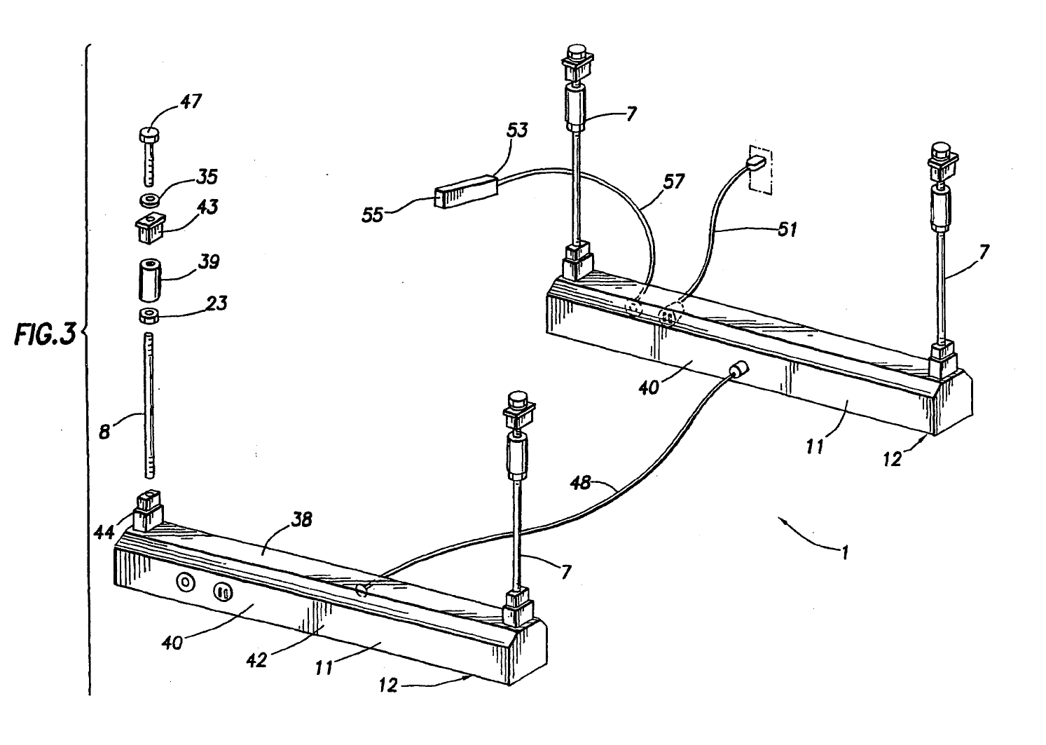

One weight sensing element 12 is shown in more detail in FIGS. 1 and 2, with weight sensing base 11 being shown in more detail. Weight sensing base 11 comprises a housing cover 40, a horizontal bar 36, a pair of weight sensing instruments 18, a thermostat 52, a heat tape 58 and a transformer 54. Each weight sensing instrument 18 comprises a foot 56, a fluid-filled instrument 16, a transducer 24 and a signal conditioner 50. Fluid-filled instrument 16 extends downward from inside housing cover 40. In this embodiment, fluid-filled instrument 16 comprises a housing 15, a fitting 25, a flexible diaphragm 20, a bolt 28 having a head 19 (not shown) and a body 2 that extends downwardly from head 19, a nut 31 and a pair of washers 32, 34 (not shown). Housing 15 resembles an inverted cup and per se has an open bottom and a top opening before being assembled, such that after assemblage, top opening is covered by fitting 25 connecting housing 15 to transducer 24. Flexible diaphragm 20 acts as a force-sensing disc having a central hole to receive the bolt 28. Flexible diaphragm 20 with bolt 28 inserted may consists of fluid tight canvas or re-enforced rubber. Flexible diaphragm 20 extends across open bottom of and is attached to bottom of housing 15, such that when bolt 28 is inserted through central hole of and the head 19 and washer 32 rests above flexible diaphragm 20, housing 15 is completely sealed off at its bottom. In one embodiment, before head 19 of bolt 28 is pushed through central hole of flexible diaphragm 20, body 2 of bolt 28 is inserted through first washer 32 which is moved upwards the central hole to rest against head 19 of bolt 28. Then, bolt 28 is pushed upwards via central hole of flexible diaphragm 20, such that first washer 32 is positioned tightly between flexible diaphragm 20 and head 19 of bolt 28. Then, second washer 34 is moved along body 2 of bolt 28, such that second washer 34 is positioned under and against flexible diaphragm 20. As a result, a pair of washers 32, 34 sandwich a portion of flexible diaphragm 20 that extends along pair of washers 32, 34. Nut 31 is then twisted upwards around body 2 of bolt 28 until nut 31 rests under and against second washer 34 and securely holds second washer 34, such that any movements of flexible diaphragm 20 will not result in any change in the position of pair of washers 32, 34. Bolt 28 is then mounted from above onto foot 56, with a lower section of bolt 28 resting stably in foot 56, a middle section of bolt 28 extending between foot 56 and housing 15 of fluid-filled instrument 16 and an upper section of bolt 28 extending inside housing 15 of fluid-filled instrument 16. Foot 56 preferably comprises solid plastic including, but not limited to, Delron. Flexibility of flexible diaphragm 20 does not allow side loading and, thus, enables accurate transmittal of the weight force imposed. Flexible diaphragm 20 may be designed to support any chosen amount of weight. In this embodiment, flexible diaphragm 20 may be designed to support up to approximately 750 to 1000 pounds for a humans bed (more for other beds. Fitting 25 fits upon housing 15 and connects housing 15 to transducer 24. Thus, fitting 25 forms a path between housing 15 and transducer 24. Any air existing in housing 15, fitting 25 and transducer 24 is extracted, preferably by a vacuum pump, and fluid is then poured in to replace the extracted air until housing 15, fitting 25 and transducer 24 are absolutely full of fluid. Then, transducer 24 is sealed on its end that is farthest from fitting 25. Transducer 24 preferably comprises a pressure to voltage transducer constructed of stainless steel. Housing 15 preferably comprises heat-treated aluminum or stainless steel. In one embodiment, fitting 25 comprises brass or stainless steel. Standard electronic wiring is used to connect transducer 24 to signal conditioner 50.

The mechanics of fluid-filled instrument 16 are hydraulic. A fluid is contained above flexible diaphragm 20 in housing 15 of fluid-filled instrument 16. A fluid used in fluid filled instrument 16 is instrument oil. In one embodiment, two fluid-filled instruments 16 are mounted on horizontal bar 36 of about 6 inches wide. Horizontal bar 36 is enclosed and insulated and, thus, is a unit. The length of horizontal bar 36 is dictated by dimensions and type of bed 3. Housing cover 40 extends above and covers each horizontal bar 36. Housing cover 40 has a top surface 38 and side surfaces 42. Either housing cover 40 or horizontal bar 36 or both must have a number of leading edges that extend along a portion of surface of horizontal bar 36 or housing cover 40 or both, respectively, to allow connecting housing cover 40 to horizontal bar 36 by using connecting means. Housing cover 40 is three-dimensional and, when placed upon horizontal bar 36, forms in combination with horizontal bar 36 a hollow enclosing body that encloses fitting 25, transducer 24, signal conditioner 50, thermostat 52, heat tape 58, transformer 54 and a portion of housing 15. Heat tape 58 is positioned between each pair of fluid-filled instruments 16. Heat tape 58 preferably extends closer to horizontal bar 36 (than to housing cover 40) and along a central section of horizontal bar 36. Position of heat tape 58 is selected in order to evenly heat all items, parts of items and space that are enclosed by housing cover 40 and that are positioned above horizontal bar 36. In one embodiment, heat tape 58 is positioned upon supports 49 extending upwards from horizontal bar 36, so that heat tape 58 is not in direct contact with and does not damage horizontal bar 36. Transformer 54 for heat tape 58, however, is preferably positioned on and connected to horizontal bar 36. In a preferred embodiment, connecting means (including, but not limited to, screws) may be used to removably connect transformer 54 to horizontal bar 36. Transformer 54 is used to control operation of heat tape 58 and is connected, preferably by electrical wiring, to heat tape 58. Thermostat 52 is preferably connected by electrical wiring to transformer 54. In one embodiment, thermostat 52 is connected by connecting means to horizontal bar 36. Thermostat 52 is individually powered. Location of thermostat 52 is chosen in order to ensure an average reading of temperature of air entrapped between housing cover 40 and horizontal bar 36. However, such locations of components of weight sensing element 12 are not intended to be limiting and are solely representing one embodiment of the invention, Signal conditioner 50 is preferably a Printed Circuit Board (PCB) comprising Central Processing Unit (CPU), Electrically Programmable Read Only Memory (EPROM), Electrically Erasable Programmable Read Only Memory (EEPROM) and Random Access Memory (RAM). Although EPROM holds operating memory, EEPROM may be useful for calibration. In addition, a power cord 51 is used for transferring electrical power to weighing apparatus 1. Power cord 51 can be plugged into weight sensing base 11 of either weight sensing element 12.

In one embodiment, a pendant assembly 53 is used for operating weighing apparatus 1. Pendant assembly 53 preferably comprises a hand-held pendant 55 and a pendant cord 57 (as shown in FIG. 3). Pendant cord 57 is plugged into and connects hand-held pendant 55 to weight sensing elements 12. Each signal conditioner 50 communicates with and transfers data to hand-held pendant 55. Hand-held pendant 55 comprises a pendant screen 59 (not shown), for demonstrating information, and control elements 60 (not shown), for controlling operation of weighing apparatus 1. In addition to digital display on pendant screen 59, there are preferably at least three control elements 60 on pendant screen 59 of pendant assembly 53. At least one control element 60 (referred to hereafter as ENTER control element) is used for selection and entrance of information. Some control elements 60 (referred to hereafter as SOFT control elements) may be used to serve various functions. Some SOFT control elements 60 may each serve different functions at different times and under different conditions. Each signal conditioner 50 is poled by pendant assembly 53 for data used for determining weight of patient.

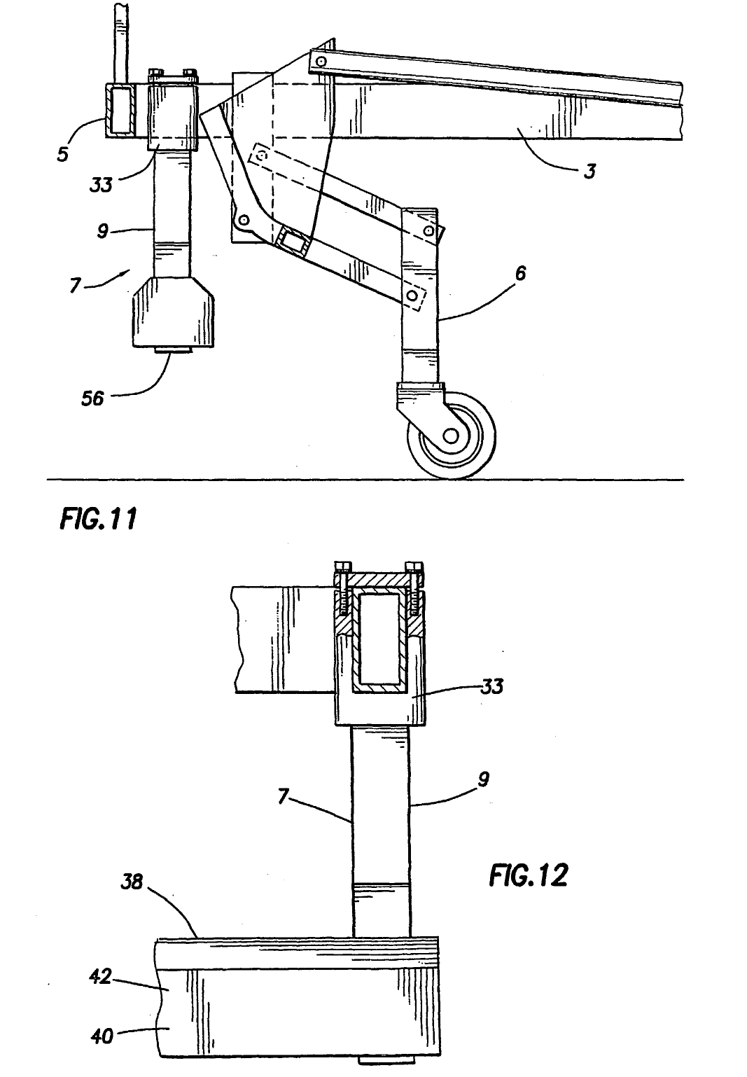

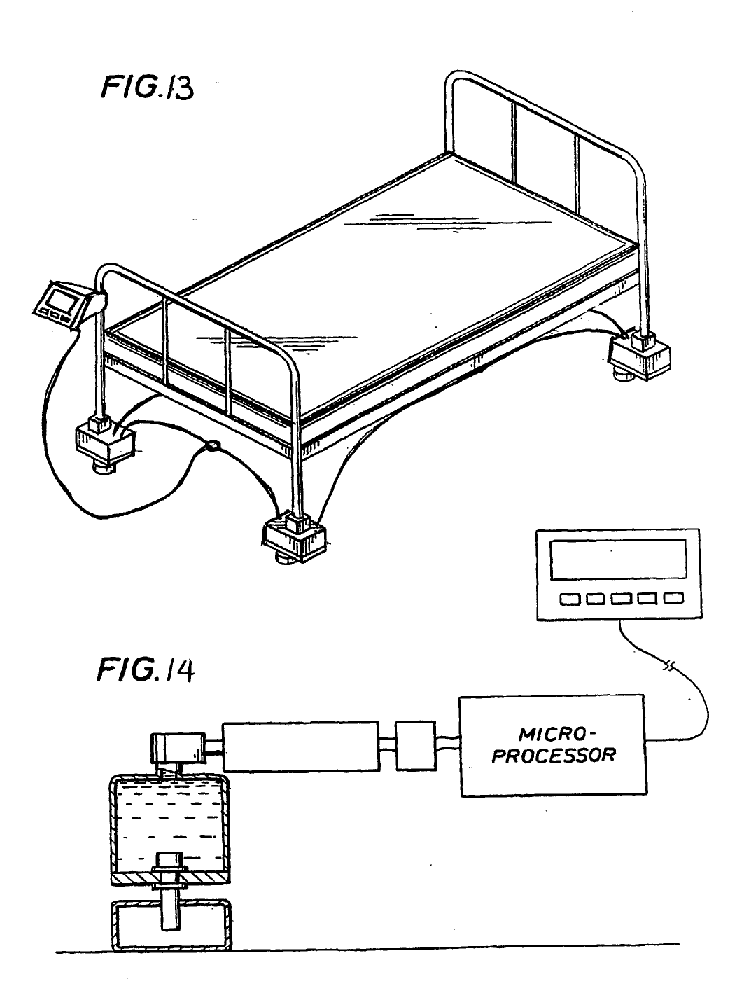

Mounting assembly 7 is used to connect weight sensing element 12 to frame 5 of bed 3 (FIG. 11) or to leg 6 of bed 3 (FIGS. 4, 5, 6 and 7). In the embodiment shown in FIGS. 4-7, each mounting assembly

7 comprises a mounting base 44, a threaded pole 8, a mounting nut 23, a nut-bushing 39, an end cap 43, a mounting washer 35 and a mounting bolt 47. Such an embodiment of mounting assembly 7 may be mounted into and via a tubing 10, that is a component of leg 6 of bed 3, to frame 5 of bed 3. In another embodiment (shown in phantom lines in FIG. 5), tubing 10 is not a component of leg 6 of bed 3, but is an extension from frame 5 of bed 3 and is not readily separable from frame 5 of bed 3. In yet another embodiment, mounting assembly 7 comprises in addition a tube 9 that is neither a component of leg 6 nor an extension from frame 5 of bed 3 and is readily removable from bed 3 (refer to FIG. 11). Tube 9 is removably connected, independent of leg 6 of bed 3, to frame 5 of bed 3. Tube 9, tubing 10 or any other such three-dimensional, hollow body (with open top and open bottom) is used to laterally surround connected components of mounting assembly 7 in order to minimize displacement and movement of connected components of mounting assembly 7. In either

embodiment, mounting base 44 extends upwardly from and above weight sensing base 11, preferably from horizontal bar 36 through and above housing cover 40. Threaded pole 8 has a threaded bottom portion and a threaded top portion. Threaded pole 8 is stably mounted onto and upon mounting base 44, with bottom portion of threaded pole 8 fitting tightly in a threaded tubular passage in uppermost section of mounting base 44. Mounting nut 23 and nut-bushing 39, which preferably are both threaded on their inner surface, are twisted in order around threaded top portion of threaded pole 8. End cap 43, having a downwardly extending open passage, and mounting washer 35 are in order placed above nut-bushing 39. Tubular lower body of mounting bolt 47 is inserted in order through mounting washer 35, end cap 43 and part of nut-bushing 39 until bottom of mounting bolt 47 rests close to and above top portion of threaded pole 8 (as shown in FIG. 9). A bottom portion of tubular lower body of mounting bolt 47 is inserted into nut-bushing 39 until mounting bolt 47 rests securely in nut-bushing 39. It should be emphasized that this version of mounting assembly 7 is only a preferred embodiment and is not intended to cause any limitations on structure of mounting assembly 7. Assemblage of mounting assembly 7 may vary slightly depending upon the type of hollow body that is used to surround the connected components of mounting assembly 7. If tubing 10 is used (as a component of leg 6 of bed 3, as shown in FIG. 4), it may be preferable to upwardly insert connected components of mounting assembly 7 into tubing 10 after nut-bushing 39 is twisted around threaded top portion of threaded pole 8. Then, mounting washer 35 and end cap 43 are moved upwards along tubular lower body of mounting bolt 47 until they reach and rest against and below head of mounting bolt 47. At this stage, mounting bolt 47, along with upper mounting washer 35 and end cap 43, is placed onto tubing 10, such that head of mounting bolt 47, mounting washer 35 and upper section of end cap 43 are positioned above tubing 10. Upper section of end cap 43 is at least of a sufficiently large surface area to be able to rest stably upon tubing 10. Meanwhile, upper section of end cap 43 has a hole that is large enough to allow insertion of tubular lower body of mounting bolt 47 there through, but small enough to prevent passage of mounting washer 35 and head of mounting bolt 47 there through. Mounting bolt 47 is then twisted downwards until bottom of mounting bolt 47 rests close to top of threaded pole 8 and mounting assembly 7 tightly holds weighing apparatus is in place and as an addendum to leg 6 of bed 3. If another tubing 10 that is not part of leg 6, but is part of frame 5, of bed 3 is used, the above set-up is used, except that weighing apparatus 1, instead of being an addendum to leg 6 of bed 3, serves as an addendum to frame 5 of bed 3.

If tube 9, which is not a component of bed 3, is used (as shown in FIG. 11), tube 9 may surround connected components of mounting assembly 7 either from manufacturing stage or before mounting assembly 7 comes into contact with bed 3. Numerous variations of tube 9 may be produced, depending on manner of mounting of mounting assembly 7 onto frame 5 of bed 3. Tube 9 may extend upwards into a mounting bracket 33 which may have various forms. If frame 5 of bed 3 has a bottom portion at head or foot of bed 3 that allows sliding of a hollow body (that is slightly larger than the bottom portion) along the bottom portion, an embodiment of mounting bracket 33 that has a shape which matches shape of that bottom portion of frame 5 is used (as shown in FIG. 12). Holes on the bottom portion of hollow body allow quick and simple attachment of mounting bracket 33 to frame 5 of bed 3. If structure of frame 5 does not allow sliding of mounting bracket 33 along bottom portion of frame 5, mounting bracket 33 may be U-shaped. In such an embodiment, holes may exist on vertical sides of mounting bracket 33, said vertical sides being positioned next to opposite vertical sides of a section of frame 5. Thus, upon placing a separate inverted U-shaped bracket upon same section of frame 5 of bed 3 whereat the U-shaped mounting bracket 33 is positioned, vertical sides (having holes) of the separate inverted U-shaped bracket rest along and parallel to and may be connected to corresponding vertical sides of the U-shaped mounting bracket 33 when holes of adjacent surfaces are aligned.

Although some other embodiments may not be presently preferred, such embodiments are not being excluded. Even only mounting base 44 and mounting bolt 47 (if of needed dimensions) may be used together, without any other components, to connect weighing apparatus is to frame 5 of bed 3. As is clearly demonstrated, weighing apparatus is may be connected to frame 5 or leg 6 of bed 3 in numerous ways, as long as some component(s) of mounting assembly 7 is (are) in some way connected to frame 5 or leg 6 of bed 3.

In addition, mounting assembly 7 may be designed in a way to allow leveling of weight sensing base 11 in order to avoid inaccuracies and inefficiency in weight measurements. As shown in FIG. 10, a mounting nut 23 may be used to enable separate adjustment of each mounting assembly 7 to ensure that weight sensing base 11 is leveled and that load is transferred evenly to all weight sensing instruments 18 of all weighing apparatus 1. In such an embodiment, a side opening exists in body of mounting base 44 at a location wherein mounting nut 23 is positioned. In order to make mounting nut 23 reachable, side opening is large enough to enable contacting and turning mounting nut 23 in order to allow upward and downward movements of threaded pole 8. Upward and downward movements of each threaded pole 8 allow desired changes in height of each mounting assembly 7 and, thus, allow leveling of weight sensing base 11. Threaded pole 8 may include a disc 14 which fits against walls of tube 9 to prevent any side movements of threaded pole 8.

The method of operation of weighing apparatus is based on a two-mode operation: TARE mode operation (i.e., operation for measuring TARE weight) and WEIGH mode operation (i.e., operation for measuring total weight), TARE weight is that data that is subtracted from the total weight so that only the patient weight is reflected. Zeroing is setting the TARE weight without the patient in bed 3. When the total weight and the TARE weight are the same, the displayed weight is zero. Adjusting is manipulating of the TARE weight manually. Adjusting allows for adding or removing items, such as accessories (including blankets, pillows, etc.), and still displaying only the patient's weight. Upon initial installation of weighing apparatus is to bed 3, and before lowering bed 3 onto weighing apparatus 1, depressing some SOFT control elements 60 results in the displayed weight to be zero on pendant screen 59. Before lowering bed 3 onto weighing apparatus 1, at least one SOFT control element 60 is depressed, causing weighing apparatus is to enter TARE mode operation. It should be ensured that all accessories are on bed 3 when the TARE weight is zeroed. The display will instruct the operator to lower bed 3. When weighing apparatus is engaged and bed 3 is resting solely on weighing apparatus 1, the electronics will in a short time and automatically take the total weight present and store that value in the TARE register. This will result in a display of 0.0 pound. To weigh a patient resting on bed 3, one SOFT control element 60 is used to select WEIGH mode operation. On pendant screen 59, instructions are displayed that Include raising of bed 3 (if bed 3 is resting on weighing apparatus 1) or lowering of bed 3 (if bed 3 is not resting on weighing apparatus 1). When weighing apparatus 1 is engaged and bed 3 is resting solely on weighing apparatus 1, automatically and electronically and in a short time, the total weight is taken, the TARE weight is subtracted from the total weight to obtain the patient's weight and the patient's weight is displayed on pendant screen 59. Anytime any accessories are to be added or removed from bed 3, some SOFT control element 60 should be enacted to select an ADJUST mode (freezing the weight of the patient on pendant screen 59 and entering TARE mode operation). The accessories should be added to or subtracted from bed 3. Pendant screen 59 instructs the operator to raise bed 3 if bed 3 is resting on weighing apparatus 1 or to lower bed 3 if bed 3 is already in raised position. When weighing apparatus 1 is engaged and bed is resting solely on weighing apparatus 1, the electronics will in a short time and automatically take the total weight, subtract the TARE weight and display the new weight of patient and accessories that were added or removed. SOFT control elements 60 now play an “ADD” and “SUBTRACT” function. The weight of the accessories is added or subtracted from the stored TARE weight of bed 3 and accessories until previous patient weight is displayed. Then, the operator depresses ENTER control element 60 to indicate completion of correction and exit the ADJUST mode. The new TARE weight is stored in the TARE memory register. The stored TARE weight in the TARE register is used as the reference value to be subtracted from the summed value of weight sensing elements 12 each time bed 3 is lowered onto weighing apparatus 1. If the patient is already in bed 3 upon installation of weighing apparatus Is and, thus, zeroing is not possible, then enter the ADJUST mode and ad adjust the displayed value to reflect the patient's weight that is recorded on the patient's chart.

Flexible diaphragm 20 eliminates side loading and transmits the weight force imposed on weight sensing element 12 by bed 3 to the fluid which becomes pounds per square inch gauge (PSIG) in fluid-filled instrument 16. Transducers 24 convert the imposed pressure to electrical signals, usually 2 millivolts per volt. Each transducer 24 is attached to each corresponding load point within weight sensing base 11. The electrical signals from transducer 24 are conditioned (amplified, modulated, etc.) by signal conditioner 50. Digital signals as raw data are converted to pounds, as determined in factory calibration stage. Each weight sensing instrument 18 has its own signal conditioner 50 comprising Central Processing Unit (CPU), Electrically Programmable Read Only Memory (EPROM), Electrically Erasable Programmable Read Only Memory (EEPROM) and Random Access Memory (RAM, i.e. flash memory). Running its own program, each weight sensing Instrument 18 conditions the signals from transducer 24, converts the analog signal to digital Information, monitors the temperature in weight sensing base 11 to allow compensation and apply calibration data to render actual weight reading. In addition, each weight sensing instrument 18 has its own individual identification number to allow reporting distinctively to pendant assembly 53, such that pendant assembly 53 distinguishes which weight sensing instrument 18 is reporting at anytime. Such information will be: current weight, current temperature, calibration constants, software version and status such as mode and error.

Upon power up, each weight sensing instrument 18 will report to User interface of pendant assembly 53 for poling protocol on the communication network. From that point the program in User interface will pole each of the weight sensing instruments 18 for data and run a control portion of the software to display, instruct and otherwise interface with the operator. The signals from signal conditioner 50 of each weight sensing instrument 18 are combined to obtain the weight of the patient.

The principals of operation of weighing apparatus 1 are a summation of load points that are established when bed 3, under its own controls, is lowered to a position that allows bed 3 and its contents to rest on weighing apparatus 1. Weighing apparatus is used to convert pounds of force (LBF) to pounds per square inch gauge (PSIG). The ratio of LBF to PSIG is kept constant by flexible diaphragms 20 and its proportions are dictated by internal surface areas of fluid-filled instruments 16. The calibration of fluid-filled instrument 16 is achieved by imbedding the proper number into EPROM to be used as a multiplier of the signal of transducer 24 to represent the amount of LBF applied to fluid-filled instrument 16.

Thus, weighing apparatus 1 essentially comprises pair(s) of mounting assemblies 7 (serving as spaced parallel beams for supporting weighing apparatus 1 above floor) and weight sensing base 11 (serving partly as pressure cylinders that support bed 3 when weighing apparatus 1 rests on floor and also including transducer 24 and signal conditioner 50 serving as an analog to digital converter to convert pressure in each cylinder to a digital quantity and to store digital quantity in memory and being positioned between the spaced parallel beams and the floor, with pressure in the cylinders being proportioned to the weight supported by the parallel beams), so that the pressure in the cylinders is indicative of the weight of bed 3 and digital raw data times multiplier equals weight of patient.

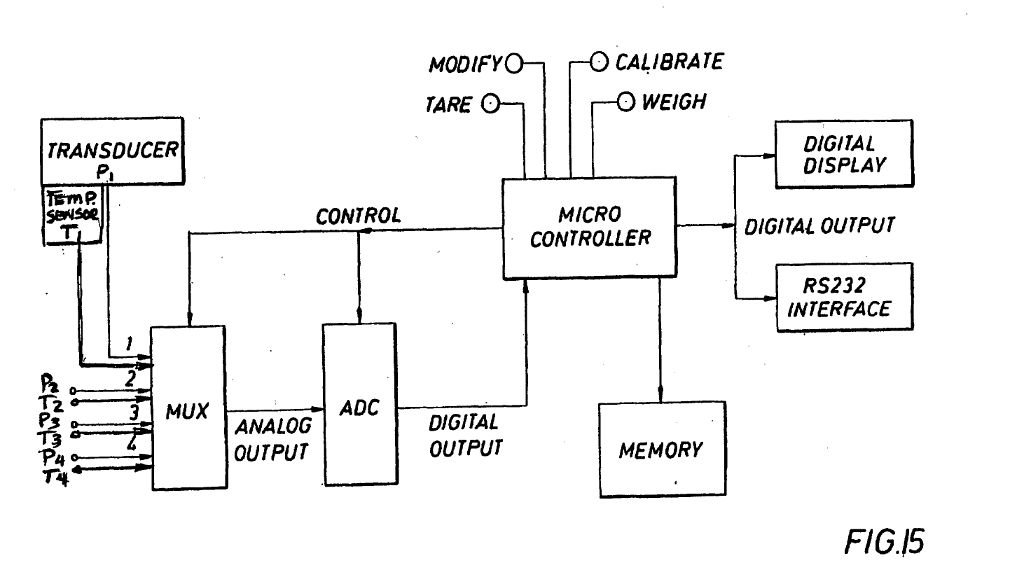

In the embodiment shown in FIG. 13 the bed 3B is shown with a plurality of sensing instruments 18, each positioned to support a leg of the bed.

One weight sensing instrument is shown in FIG. 14. Generally, the bed 3 will be supported when it is to be weighed, by a plurality of the weight sensing instruments 18 detachably or permanently attached to the bed at or adjacent to the head and foot of the bed for stability.

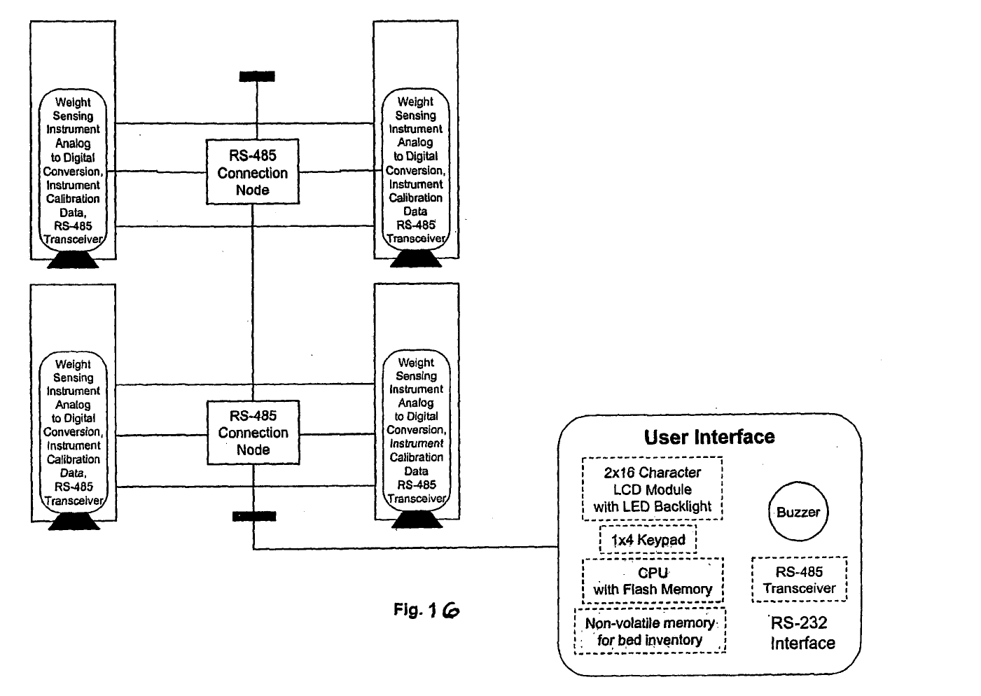

The weight sensing arrangement is shown in FIGS. 13-14, with cylindrical weight hydraulic sensing instruments 18 constructed as depicted and as discussed with respect to FIGS. 2 and 5 above and FIG. 14 below. These weight sensing instruments support the bed simultaneously and the output of the sensors and their corresponding transducers is converted and calibrated to provide accurate weight at each leg and the combined output provides the total weight. To maintain accuracy one or more temperature sensors are provided to allow the output to be calibrated for different temperature conditions so that circuitry or computer program software or hardware can be provided to compensate for the sensed temperature when providing the weigh measurement at the user interface the transducer out put might be compensated at the sensor or the resultant measurements might be compensated at the user interface. The output of the transducers form the these four temperature sensors is summed electronically by the circuit shown in FIG. 15 to produce the final output. An analog to digital converter produces a digital signal representative of the total output The signals from the transducers are at a microvolt level. The signals are applied to a nearly infinite impedance input of four instrumentation amplifiers (IAs). The outputs of the IAs are fed to the summing input pin of an amplifier. The gain of the amplifier is controlled by a variable resister. The summed output is then fed to a 10 hertz filter to remove noise from the signal and to a comparator.

The purpose of the comparator is to signal to the microprocessor U4 when the output of summing amplifier U1:B crosses zero volts. When pushbutton switch PB1 is depressed, micro U4 outputs 5 volt pulses to digit analog converter (DA) LTC1451. The incremental analog output voltage, pin 10 of the LTC1451, is fed to inverting amplifier U1:A, whose output pen 1 is fed to the same summing junction as the reaches the negative equivalent of the summed outputs of the 41A's comparator U3 will change logic levels and stop the TARE process. Therefore, any tune the TARE button is depressed, the output of U1:B will revert to zero volts. Again, the output of U1:B is fed to a 10 hertz filter. The output of the filter, N1, U2:B, is fed to a final zero amplifier, U2:B. The output of U2:B, pin 7 is the final output of electronic circuit can be interpreted by suitable digital volt meter to indicate the weight of the patient.

In summary, the circuitry that produces the signal that indicates the way the patient acts as follows. The signal produced by the diaphragm transducers requires a large amount of amplification and as a result, the circuitry, must be designed to reduce the impact of noise and temperature. There are four amplifiers U6, U7, U8, and U9, one. The output of each of these amplifiers represents the weight on The outputs of these four amplifiers are summed together in a summing amplifier (U1:B). The output of this amplifier represents the total weight. In the low-pass amplifier, U2:A high frequency noise is filtered out. The signal is output to the digital volt meter, where the weight is displayed in a digital readout.

The handling of the tare portion is as follows. To compensate for the impact of temperature on the accuracy, as wall as zeroing the weight of any blankets or pillows, a microcontroller and a digital-to-analog converter (DAC) are used. When the “TARE” pushbutton is pressed, the microcontroller starts to bring the voltage of the DAC up from zero. This signal is subtracted from the summing amplifier. When the output of the summing amplifier reaches zero volts, the comparator, U3, changes state and the microcontroller stops raising the DAC output. The circuit is now ‘zeroed’ out. The step has to be performed before the patient is put on the bed. All items that are on the bed when this step is performed must be there whenever a measurement is made, or the reading will not be accurate.

An alternate method of accomplishing the summing and tarring of the signals from the 4 force sensors is:

Briefly, the alternate method will rely on mostly digital signal processing as opposed to the analog processing described above. In this alternate method, the analog signals from the sensors will be applied to a 4 channel multiplexer (MUX). A MUX is an integrated circuit that will increment from one input to the next, then the next and so forth. In this case, after it processes the fourth input, it will revert to the first. The output of the MUX is still an analog voltage that is then applied to the input of an analog to digital converter (ADC). The ADC converts the analog signal of the first input and the MUX to a digital signal. It then signals to the MUX that it is ready for the next input and the MUX obliges by incrementing to it's second input. This sequence of events continues until the fourth input has been processed and the MUX reverts to the fist input. The process may stop here or continue for several cycles and then stop. The purpose of continuing the process would be to provide some averaging of the signals if it were felt necessary.

The output of the ADC is a digital signal or word that is stored in a memory register. As each input to the MUX is scanned, the output of the ADC changes to reflect the digital equivalent of analog input to the MUX. As the digital output increments, the outputs are digitally summed or added in the memory register and after 3 additions, the contents of the memory register is transferred to another memory location. If several cycles are performed, the output of the ADC for each cycle is stored in another memory location. At the end of the process, the ADC stops processing signals. Under microcontroller control, the outputs of these memory locations are summed, and then averaged and stored in an output memory register. Noise in the analog circuit portion of the electronics will determine if averaging several cycles is necessary. If noise is not a problem, then only one cycle would be needed to arrive at the final summation of the 4 inputs to the MUX, and the output of the summation memory register would be transferred to the output memory register.

The contents of the output memory register, again under microcontroller control, is converted to both a digital display that is mounted on the face of the electronics enclosure and an interface circuit for input to a computer. This conversion is scaled to represent the weight of the patient occupying the bed.

The method is based on 2 mode operation, TARE and WEIGH. There will be 3 buttons on the face of the electronics enclosure in addition to the digital display. They will be labeled ADD, SUBTRACT and ENTER Upon initial installation of the weighing system to a bed, and before lowering the bed onto the weighing system, depressing both ADD and SUBTRACT causes the output register to display zero. Before lowering the bed and its accessories (blankets, pillows etc.) Onto the weighing system, the ADD button is depressed causing the electronics to enter the TARE mode. After lowering the bed onto the force sensors, the enter button is depressed, storing the weight of the bed in memory, when it will be subtracted from subsequent measurements to reflect only the weight of the patient. Anytime an item is to be added or removed from the bed, the bed should be resting on the sensors, the ADD or SUBTRACT button depressed (freezing the weight of the patient display and entering the TARE mode), the item added or subtracted from the bed and the ENTER button depressed When the ENTER button is depressed, the system leaves the TARE mode), and returns to the WEIGH mode. The weight of the item is added or subtracted from the stored tare weight of the bed and accessories. The new tare weight is stored in the TARE memory register. The stored value in the TARE register is used as the reference value to be subtracted from the value of the summed value of the 4 sensors each time the bed is lowered onto the sensor system. The display is activated upon this action and is deactivated upon raising the bed off the sensor, so that only the weight of the patient is ever displayed. Each time the bed starts to lower, the value in the TARE register is compared to the value in the weight register and any difference is applied to the weight register so that they are equal and of opposite values. (In this method, the value in the WEIGH register should always be the negative equivalent of the TARE register). This procedure insures that only the weight of the patient is displayed when the bed finally rests on the sensor system. It is obvious from this description that the only change in the concept of the entire system is the use of digital technology, much of which has only recently become economically viable, instead of the older analog technology. Use of this digital technology increases accuracy and reliability. In this there is no attempt to identify the integrated circuits involved, since they will be chosen on primarily a price/performance ratio and on desired technical specifications.

In a further improved embodiment a memory in the user interface or in the handheld pendant can periodically poll and record the weight. The data can be recorded, stored and displayed or printed as desired by the user to show weight gain and weight loss trends, over a desired period of time and at selectable intervals.

Certain objects are set forth above and made apparent from the foregoing description, drawings and examples. However, since certain changes may be made in the above description, drawings and examples without departing from the scope of the invention, it is intended that all matters contained in the foregoing description, drawings and examples shall be interpreted as illustrative only of the principles of the invention and not in a limiting sense. With respect to the above description and examples then, it is to be realized that any descriptions, drawings and examples deemed readily apparent and obvious to one skilled in the art and all equivalent relationships to those stated in the examples and described in the specification or illustrated in the drawings are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is also to be understood that the following claims are intended to cover all of the generic and specific features of the invention herein described, and all statements of the scope of the invention which, as a matter of language, might be said to fall in between.

1. A weighing apparatus comprising a plurality of weight sensing elements that each comprises:
a. at least fluid-filled instruments and an analog to digital converter; and
b. a mounting assembly supporting and holding each weight sensing and being connected directly or indirectly to a bed that is being weighed;
such that, when the bed is solely supported by the weight sensing instruments, any pressure exerted on the fluid-filled instruments is indicative of the weight of the bed and of any objects or living things held or supported by the bed as indicated by the analog to digital converter connected to the fluid-filled instrument.

2. The weighing apparatus of claim 1, wherein each weight sensing instrument comprises in addition to the fluid-filled instrument, at least:
a. a foot supporting from below the fluid-filled instrument;
b. a transducer connected at one end via a fitting to top of the fluid-filled instrument and the fluid filled instrument sealed at another end; and
c. a signal conditioner connected to the sealed transducer.

3. The weighing apparatus of claim 2 wherein each fluid-filled instrument comprises:
a. a housing having a flexibly sealed bottom and a top opening that is covered by the fitting connecting the housing to the transducer;
b. a flexible diaphragm sealingly extending across the bottom of and attached to the housing to form a force-sensing disc having a central hole;
c. a bolt having a head and a body, the head enclosed by the housing, and the body, that extending downwardly from the head and attached to the foot thereby supporting the fluid-filled instrument above the foot;
d. a pair of washers, with the first washer being positioned tightly between the flexible diaphragm and the head of the bolt and with the second washer being positioned under and against the flexible diaphragm; and
e. a nut that resting under and against the second washer;
such that the bottom of the housing is sealed off when the fluid-filled instrument is being assembled and before the housing, the fitting and the transducer are filled with fluid and before the transducer is sealed.

4. The weighing apparatus of claim 3, further comprising:
a. a housing cover, with the fluid-filled instrument extending downward from inside the housing cover; and
b. a horizontal bar, with the horizontal bar and the housing cover forming a hollow enclosing body that encloses the transducer, the signal conditioner, the fitting and part of the housing.

5. The weighing apparatus of claim 3, wherein the flexible diaphragm comprises canvas or re-enforced rubber, the foot comprises a solid plastic, the fitting comprises brass or stainless steel, the transducer comprises stainless steel and the housing comprises heat-treated aluminum or stainless steel.

6. The weighing apparatus of claim 2, wherein standard electronic wiring is used to connect the transducer to the signal conditioner.

7. The weighing apparatus of claim 3, wherein the fluid-filled instrument contains instrument oil.

8. The weighing apparatus of claim 2, wherein the signal conditioner includes a Printed Circuit Board comprising Central Processing Unit, Electrically Programmable Read Only Memory, Electrically Erasable Programmable Read Only Memory and Random Access Memory.

9. The weighing apparatus of claim 2, wherein the weight sensing element further comprises:
a. a thermostat enclosed by the hollow enclosing body and individually powered;
b. a heat tape enclosed by the hollow enclosing body; and
c. a transformer connected to the heat tape and to the thermostat and enclosed by the hollow enclosing body.

10. The weighing apparatus of claim 1, wherein a power cord is connected to one weight sensing base.

11. The weighing apparatus of claim 1, wherein the weighing apparatus further comprises a pendant assembly that is connected to one weight sensing base and that is used for operating the weighing apparatus.

12. The weighing apparatus of claim 10, wherein the pendant assembly comprises:
a. a hand-held pendant which receives data from the signal conditioner and which comprises at least a pendant screen used for demonstrating information and received data and control elements used for controlling operation of weighing apparatus; and
b. a pendant cord that connects the hand-held pendant to the weight sensing element.

13. The weighing apparatus of claim 1, wherein a communication cable connects each pair of weight sensing bases to one another.

14. The weighing apparatus of claim 1, wherein each mounting assembly comprises at least:
a. a mounting base extending upwardly from and above the weight sensing base;
b. a threaded pole having a threaded bottom portion and a threaded top portion being stably mounted via its threaded bottom portion onto and upon the mounting base;
c. a mounting nut having a threaded inner surface and being twisted around threaded top portion of the threaded pole;
d. a nut-bushing having a threaded inner surface and being twisted around threaded top portion of the threaded pole above the mounting nut;
e. a tube positioned upon and onto the mounting base;
f. an end cap, having a downwardly extending open passage, being positioned on top of the tube;
g. a mounting washer positioned above the end cap; and
h. a mounting bolt inserted through the mounting washer and the end cap;
such that the mounting assemblies stably hold the weight sensing base connected to the bed.

15. A method of weighing a patient lying in a bed comprising supporting the bed on fluid filled instruments, determining the tare weight of the bed from the pressure in the fluid-filled instruments, determining the total weight of the bed and the patient from the pressure in the fluid filled instruments supporting the bed and the patient and subtracting the predetermined tare weight to determine the weight of the patient.

16. The method of claim 20 in which the tare weight of the unoccupied bed is obtained by means of supporting each leg of the bed while the bed is unoccupied.

17. Apparatus for weighing a patient in a bed, said apparatus comprising spaced parallel beams, for supporting apparatus above floor, and pressure cylinders, supporting the beams, the patient and the bed when apparatus rests on floor, so that the pressure in the cylinders is indicative of the weight of the bed and the patient.

18. Apparatus for weighing an occupant of a bed, the apparatus comprising at least a pair of mounting assemblies, for supporting apparatus above floor, and weight sensing base being positioned between the bed and the floor, serving partly as pressure cylinders that support the mounting assemblies, the bed and the occupant when apparatus rests on floor and comprising at least a transducer and a signal conditioner for converting pressure of the pressure cylinders to a digital quantity to be stored in memory and to be proportioned to weight supported by the apparatus.

19. The weighing apparatus of claim 2, further comprising:
a. said plurality of weight sensing instruments comprising one at each leg of the bed;
b. a temperature sensor at each temperature sensing instrument to provide a temperature signal for use to compensate for variations in the temperature; and
c. a computer programm for recieving the signal form the temperature sensor and for making compensation for the variations in the temperature to the weight measurement.

20. The weighing apparatus of claim 1, further comprising a computer program and memory storage for periodically measurijng and recording weight changes over time to provide the user with weight trending information.
